(19) United States
(12) Patent Application Publication
(10) Pub. No.: US 2026/0212005 A1
(43) Pub. Date: Jul. 23, 2026

(54) SYSTEMS AND METHODS FOR INTERACTION STACKING DETECTION

(71) Applicant: EQUIFAX INC., Atlanta, GA (US)

(72) Inventors: Arunkumar Ranganathan, Atlanta, GA (US); Dilip Singh, Alpharetta, GA (US); Adam Michael Ames, Pittsboro, NC (US)

(21) Appl. No.: 19/457,453

(22) Filed: Jan. 23, 2026

Related U.S. Application Data
(60) Provisional application No. 63/748,648, filed on Jan. 23, 2025.

(51) Int. Cl. G06F 21/55

(52) U.S. Cl. CPC G06F 21/552; G06F 2221/033

(57) ABSTRACT

A method can include receiving a request associated with an interaction involving a target entity. The method can include receiving identity data about the target entity and historical data about historical interactions associated with the target entity. The method can include providing the identity data to a first machine-learning model to generate first output. The method can include applying the historical data to rules to generate rule outcomes. The method can include providing the rule outcomes to a second machine-learning model to generate second output. The method can include generating a recommendation including a response to the request. The method can include providing a responsive message including a command executable to automatically control the response to the request.

### CROSS-REFERENCE TO RELATED APPLICATION

This claims priority to U.S. Provisional Application No. 63/748,648, entitled “Systems and Methods for Interaction Stacking Detection,” filed on Jan. 23, 2025, the entire content of which is hereby incorporated by reference in its entirety.

### TECHNICAL FIELD

The present disclosure relates to machine-learning and artificial intelligence. More specifically, but not by way of limitation, the present disclosure relates to artificial intelligence techniques for interaction stacking detection.

### BACKGROUND

Organizations that provide access to digital resources or services can encounter challenges in evaluating user eligibility and monitoring user interactions as online platforms and service offerings expand. The widespread adoption of digital access mechanisms has resulted in increasingly complex environments characterized by high volumes of user interactions and requests. The organizations may receive a number of requests that are fraudulent or otherwise associated with malicious intent. Determining which requests are fraudulent or otherwise associated with malicious intent, and preventing such requests from being executed, can be difficult.

### SUMMARY

Aspects of the disclosed technology can include any combination of the features described herein. For example, a method can include receiving, from a computing device, a request associated with an interaction involving a target entity. The method can include receiving data about the target entity in which the data includes (i) identity data about the target entity and (ii) historical data about historical interactions associated with the target entity. The method can include providing the identity data about the target entity to a first machine-learning model to generate first output that includes a probability score indicating a likelihood that the request is not a legitimate request. The method can include applying the historical data about historical interactions associated with the target entity to a set of rules to generate a set of rule outcomes. The method can include providing the set of rule outcomes to a second machine-learning model to generate second output that includes a risk level indication of whether the request is legitimate. The method can include generating, by combining the first output and the second output, a recommendation that includes a response to the request. The method can include providing a responsive message to the computing device, the responsive message including a command executable to automatically control the response to the request.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which machine-learning techniques can be used for controlling interaction requests based on detecting interaction stacking according to some aspects of the present disclosure.

FIG. 2 is a flowchart illustrating an example of a method for controlling interaction requests based on detecting interaction stacking using machine-learning techniques according to some aspects of the present disclosure.

FIG. 3 is a data flow diagram of a data flow for generating a recommendation using machine-learning techniques to detect interaction stacking according to some aspects of the present disclosure.

FIG. 4 is a data flow diagram of a data flow for generating a probability score using a machine-learning model based on identity data according to some aspects of the present disclosure.

FIG. 5 is a data flow diagram of a data flow for generating a risk level indication of risk using a machine-learning model based on historical interaction data according to some aspects of the present disclosure.

FIG. 6 is a block diagram depicting an example of a computing device, which can be used to implement the embodiments described herein, according to some aspects of the present disclosure.

### DETAILED DESCRIPTION OF THE INVENTION

Certain aspects and examples of the present disclosure relate to machine-learning techniques that can be used to detect interaction stacking requests and provide recommendations or control over the interaction stacking requests. Interaction stacking can include multiple requests for different interactions submitted by a common entity within a short period of time such as less than 120 days, 90 days, 60 days, and so on. The machine-learning techniques can involve different rules and machine-learning models that can be used to model risk levels and probabilities that identified interaction stacking instances are associated with malicious intent such as an intent by a requesting or target entity to not fulfill terms of the respective interactions. The machine-learning models can generate rules, can receive rules as input, or a combination thereof in support of detecting interaction stacking requests or controlling responses to detected interaction stacking requests.

Certain aspects described herein, which can include machine-learning techniques for detecting interaction stacking requests and controlling responses thereto, can improve at least the technical fields of controlling interactions between computing environments, machine-learning, or a combination thereof. For instance, by using the machine-learning techniques disclosed herein, interactions can more precisely be controlled compared to other systems and techniques at least since fewer malicious interactions are allowed. Additionally, machine-learning is improved by the machine-learning techniques. Examples of the improvements to machine-learning include improved accuracy and efficiency over other systems and techniques by using the machine-learning architecture disclosed herein. For example, an ensemble model and separate models can be used to generate rules, to receive attributes based on the generated rules as input, and to generate outputs that are more accurate than other models. The architecture of the combination of the machine-learning models is also unconventional compared with other models.

In some examples, interaction stacking can occur when an entity engages in an interaction without actually intending to complete the interaction or with an intention to receive resources without providing an agreed-upon return for the resources. The interaction stacking may be associated with malicious intent. For example, an entity may engage in interaction stacking to bypass or obfuscate risk assessment analyses to cause fraudulent interactions to be completed or to perform other similar malicious actions.

A system, such as the system disclosed herein, can address interaction stacking using artificial intelligence or machine-learning techniques. For example, the system can leverage multiple machine-learning models to detect or identify requests for interactions that are associated with interaction stacking, to remedy or otherwise control the requests, or any combination thereof. The artificial intelligence or machine-learning techniques can involve multiple advanced machine-learning models or algorithms that can be applied to various data or combinations of data.

The machine-learning models can be generated or trained to perform multiple tasks with respect to detecting or controlling requests associated with interaction stacking. For example, the machine-learning models can generate scores to predict a likelihood that a request is associated with interaction stacking, can generate one or more rules to identify behavior likely to be associated with interaction stacking requests. In some examples, a first machine-learning model may be constructed and trained to generate the scores, and a second machine-learning model may be constructed and trained to generate the one or more rules. In other examples, the one or more rules may be generated separately from the machine-learning models and can be integrated with the machine-learning models.

The machine-learning models, or the system, can identify requests in which target entities are engaged in interaction stacking. The machine-learning models, or the system, can identify whether requests that are likely to be engaged in interaction stacking are doing so legitimately or are doing so with malicious intent. In some examples, malicious intent may include requesting a loan with no intention to satisfy the terms thereof. The system can facilitate, such as perform, empirical data analysis to define one or more interaction stacking labels to support identification or control of requests associated with interaction stacking. The labels can be derived to identify target entities that have submitted multiple interaction requests within a predefined threshold of time and that have a high likelihood of not meeting the terms of the requests.

A base population can be generated from historical data about a set of entities. The set of entities may have previously submitted a request to engage in an interaction in the predefined threshold of time or in other suitable time periods. The historical data can be filtered to select data most appropriate for the base population. For example, a particular type, or particular types, of interactions may be selected or omitted for the base population. The system can identify whether each interaction identified in the base population is bad such as a failed interaction. Interaction stacking labels, such as not interaction stacking, intentional good interaction stacking, intentional bad interaction stacking, and the like can be generated based on the base population.

Attributes can be added to or otherwise associated with the base population. For example, various inquiries, identity and fraud verifications, and the like can be joined with the base population or otherwise applied to the base population, which can be down sampled. The down sampled population can be split into training data and testing data such as by using a train test flag label. The data may be randomly, or pseudo-randomly, distributed among the test flag labels and into the training data and the testing data. Good labels and bad labels may be consistent prior to splitting the base population and after the base population is split into the training data and the testing data.

The attributes may be generated based on data from various sources. For example, the sources can include a database used or otherwise maintained by entities that facilitate or process interactions. Another source can include a detokenized database that can include personally identifiable information that are not tokenized or encrypted. Another source can include a database that includes historical interaction inquiries associated with various entities. Another source can include property data that can be provided by or maintained by a government or other public entity. Another source can include a database of wireless service providers, landline service providers, utility providers, and the like.

In some examples, target entity associated with interaction stacking can be labeled as bad if at least two interactions were requested and at least one of those interactions were initiated but the target entity did not satisfy the terms of the interaction after a predetermined number of days. The predetermined number of days can include 60 days, 90 days, 120 days, 365 days, or so on. A target variable for the machine-learning models can include “Bad 1” that can indicate that a target entity has engaged in interaction stacking with at least one interaction not fulfilled. To be able to distinguish between different levels of risk associated with different entities, a second target variable, such as “Bad 2,” can be used for the machine-learning models. The second target variable can indicate that a target entity has at least two interactions associated with interaction stacking that remain unfulfilled after the predetermined time, which may indicate a higher risk that the first target variable.

Empirical data analysis can be performed to define the first target variable, the second target variable, other target variables, or any combination thereof. An objective of the data analysis may include maximizing a volume of labels of “bad” while minimizing the time window. The data analysis may include multiple steps. For example, a first step can include determining a cut-off to distinguish between a good interaction stacking request and a bad interaction stacking request, and a second step can include determining whether the time window can be further reduced without reducing a quality of the data or labels. In the first step, interaction stacking entities can be defined as entities that have requested two or more interactions within a short period of time. An interaction stacking bad label can be defined as any of the foregoing entities that have one or more interactions that are bad such as that were not fulfilled or that were violated. A threshold for distinguishing between interaction stacking bad and interaction stacking good can be determined by comparing interaction stacking volume and interaction stacking bad volume in different scenarios and over different periods of time.

In the second step, the dataset can be tested to determine whether a performance window, or the period of time, can be shortened to make the machine-learning models more efficient at inference. In some examples, different periods of time or time windows can be selected to determine whether the dataset retains acceptable coverage of “interaction stacking bad” labeled data. The dataset can be optimized to maximize the number of interaction stacking bad labeled data while minimizing the time window for optimized machine-learning performance. In some examples, the optimized dataset can be appended with personally identifiable information from detokenized databases. Examples of the personally identifiable information can include name, unique identification number, phone number, address, and the like, and the information may be collected from a last known or most recent data source. Additionally, or alternatively, the appended dataset can be sampled to improve, such as reduce, processing time of the machine-learning models. In some examples, at least a portion of the dataset may not be sampled and may be fully used by one or more of the machine-learning models. For example, inquiry data may not be sampled and may be fully used, while identity data may be down sampled such as by selecting a subset of interaction stacking good-labeled data and selecting all of the interaction stacking bad-labeled data.

Attributes can be determined for the artificial intelligence techniques. For example, and for inquiry data or historical interaction data, the data can be prepared. Preparing the data can include filtering data taken from one or more data sources such as by removing data points with no unique identification number or by selecting a subset of the data within a predetermined time window. The attributes can be computed based on the filtered data on the unique identification number level within the time window, and the inquiry data with the attributes can be rejoined with the dataset. Some examples of the attributes can include different dimensions of the data such as volume, recency, frequency, and type with respect to the historical interactions or historical inquiries. The volume may indicate a number of requests submitted by a target entity before an account is opened within a certain amount of time. The recency may indicate an average time for requests before account opening within a certain amount of time. The frequency may indicate an average time between requests at a certain time before account opening. The type may indicate types of requests submitted within a certain period of time.

The dataset with attributes can be used to train, or otherwise facilitate generation of, one or more machine-learning models. The machine-learning models can be developed to perform multiple tasks. For example, a first machine-learning model can be developed and trained to perform a first task, and the second machine-learning model can be developed and trained to perform a second task. In some examples, the first task can include generating a first score, such as a decision score, on first data, and the second task can include generating a second score, such as a recommendation rule score, on second data that may be similar or different from the first data. The first machine-learning model can use the first data that can include identity data, and the second machine-learning model can use the second data that can include request data or historical data.

The machine-learning models can include one or more different types or architectures of models. For example, the machine-learning models can include an XGBoost model, a machine-learning gradient boosting (MLGB)-rules model, a decision tree model, other suitable models, or any combination thereof. The XGBoost model can include an optimized, distributed, gradient-boosting library designed to be efficient, flexible, and portable and can implement machine-learning algorithms using a gradient-boosting framework such as a parallel tree boosting framework. In some examples, the XGBoost model can implement extreme gradient boosting for regression and classification techniques using decision trees and can prevent or otherwise control over-fitting.

The MLGB-rules model can include a Python-based machine-learning model built with scikit-learn. The MLGB-rules model can learn logical, interpretable rules for detecting a target class with high prevision. The decision tree machine-learning model can include a non-parametric supervised machine-learning model. The decision tree machine-learning model can include a classifier to build a final ensemble of rules from the MLGB-rules model. In some examples, the decision tree model can use a Gini impurity to split classes into binary groups. The Gini impurity can include a probability of misclassifying an observation, as in Equation 1 produced below.

$$G = i = \sum C p ( i ) * ( 1 - p ( i ) ) \qquad ( 1 )$$

C is the number of classes and p(i) is the probability of randomly picking an element of a class.

The first machine-learning model, such as the decision score model, can receive identity data as input and can generate a first score as an output. In some examples, the first machine-learning model can include an ensemble of models configured to generate the first score. The ensemble of models can include an XGBoost model trained on interaction stacking bad 1-labeled data and can include a decision tree model trained on interaction stacking bad 2-labeled data. The decision tree can be combined with the XGBoost model to generate the first score as output. In some examples, model segmentation can be performed to control or otherwise prevent a solution that is over-fitted. The model segmentation can be performed to capture higher instances of interaction stacking bad that may optimize resource losses based on the interaction stacking. In some examples, L1 and L2 regularization techniques can be used to penalize large weights and to promote simpler models. Additionally, or alternatively, tree-specific parameters, such as maximum tree depth, minimum child weight, and gamma (a pseudo-regularization parameter), can be used to provide control over tree complexity and to prevent over-fitting.

A baseline model for the machine-learning models can be developed. The baseline model may be initialized using each possible feature based on the dataset. A feature selection process can be performed with respect to the baseline model. Feature selection can be performed to generate an optimized set of features for model development while ensuring substantial representation of variables from various attribute data sources. In a first step of feature selection, a subset of the attributes can be removed. For example, some attributes that do not exceed (or that do exceed) a threshold value while retaining a top number of attributes can be removed from the baseline model. Additionally, or alternatively, synthetic attributes can be removed. Additionally, or alternatively, unstable attributes and attributes having 100% correlation can be removed. In a second step of feature selection, a top number of remaining attributes can be selected, and some attributes can be removed based on correlation. Additionally, or alternatively, a recursive feature elimination and cross-validated selection technique can be used to select a subset of remaining features. In a third step of feature selection, another top number of features from the first step and the second step can be selected and deduplicated.

The features, or the attributes, can include various attributes that can influence performance of the machine-learning models. The features can fall into one of various categories such as life event, identity discrepancies, suspicious activity, identity verification, demographics, and other. In life event, examples of the attributes can include (i) a time since a resource record change, (ii) recency of a particular type of request, (iii) a number of requests related to a particular industry or sector in recent time, (iv) matches between request and identity data, (v) recency of an address change, (vi) time since last activity on a particular account, and (vii) a number of different industries or sectors associated with requests. In identity discrepancies, examples of the attributes can include (i) mismatches in identifying information from different sources, (ii) a number of partial matches between identifying attributes, (iii) discrepancies in industries associated with requests, (iv) mismatches between reported and verified information, (v) differences in data linked to requests, (vi) a number of inconsistencies with a particular attribute across records, (vii) counts of shared data points across entities, and (viii) a number of mismatches in data points. In suspicious activity, examples of the attributes can include (i) frequency of a particular type of request within a specific time, (ii) a degree of similarity between reported and verified information, (iii) a number of different locations linked to records of a target entity, (iv) a time since last discrepancy between reported and verified information, (v) a number of hard requests from various sectors, (vi) a number of address records identified, (vii) a number of requests related to a specific sector in a certain time, and (viii) a number of requests from a different sector in a specific time window.

In identity verification, examples of the attributes can include (i) a number of matches between different elements of identity data, (ii) discrepancies between user-provided data and secondary data, (iii) an agreement between identifiers obtained through various means, (iv) counts of overlapping information across data points, (v) differences between user-provided and alternate data elements, (vi) matches of subsets of identifying attributes, (vii) presence of restrictions on data sharing, and (viii) exact matches of reported data. In demographics, an example of the attributes can include a number of differences within demographics attributes. In other, examples of the attributes can include (i) hard and soft requests within different industries and subgroups, (ii) interactions initiated within a first, small, predetermined time window, (iii) presence of notifications related to potential fraud or other malicious activity, (iv) interactions initiated within a second, smaller, predetermined time window, and (v) a count of records related to mortality. In some examples, the model can undergo hyperparameter tuning such as to improve processing time by iterating a set of parameters and reducing less important parameters while selecting better or more important parameters. A best or better parameter may include a parameter that provides a lowest separation among training data and testing data.

An output of the model can include a probability score indicating whether an input request is associated with an interaction stacking bad label. The probability score may range from zero to one, inclusive, and the probability score can be converted to an output score with a different range. The higher the output score, the more likely that the request is associated with interaction stacking bad, and vice versa.

A machine-learning model from the machine-learning models can be developed for generating a decision score. Data can be prepared for the machine-learning model. For example, training data can be generated using a bottom portion of accounts based on an XGB model score. In some examples, the machine-learning model can be based on a gradient boosting rules model, and the machine-learning model can be trained on the training dataset while iterating over a set of precision and recalls to generate rules. The rules can be transformed into attributes to be used in a decision tree model. In some examples, rules can include individual conditions using identity data or attributes. A ruleset can include a combination of rules to form a branch of the decision tree or ruleset, and logic can include a combination of rulesets to form a full decision tree.

The machine-learning models can use XGBoost as one or more of the machine-learning models to generate output. XGBoost can include a highly optimized implementation of gradient boosting to construct an ensemble of weak learners such as decision trees. XGBoost can iteratively add trees to the ensemble to correct errors of predecessors. In some examples, XGBoost can optimize a regularized objective function as in Equation 2 produced below.

$$Obj ( θ ) = L ( θ ) + Ω ( θ ) \qquad ( 2 )$$

L(θ) is the training loss function that measures the difference between predicted and actual values. Common loss functions can include squared loss for regression (Equation 3, produced below) and logistic loss for classification (Equation 4, produced below).

$$L ( θ ) = {\sum }_{i} {( {\hat{y}}_{i} - {y}_{i} )}^{2} \qquad ( 3 )$$

$$L ( θ ) = {\sum }_{i} [ {y}_{i} ln ( {\hat{y}}_{i} ) + ( 1 - {y}_{i} ) ln ( 1 - {\hat{y}}_{i} ) ] \qquad ( 4 )$$

in which yᵢ is the actual value and ŷᵢ is the predicted value. In some examples, Ω(θ) is a regularization term that penalizes model complexity to prevent overfitting. Examples of regularization can include L2 regularization and L1 regularization, as in Equations 5 and 6, respectively, produced below.

$$Ω ( θ ) = λ {\sum }_{j} {w}_{j}^{2} \qquad ( 5 )$$

$$Ω ( θ ) = λ {\sum }_{j} \vert {w}_{j} \vert \qquad ( 6 )$$

In Equations 5 and 6, wⱼ represents the weights of the trees and A is the regularization parameter.

The model can construct trees using a greedy approach such as by selecting a split that maximizes a gain in the objective function at each node. Additionally, or alternatively, the model can handle missing values by learning an optimal direction for missing values during training. For each split in the decision tree, the model can consider both possible branches for missing values and can choose the direction that maximizes the gain. The model can use a second-order approximation, such as a Taylor approximation (Equation 7, produced below), of the loss function to improved optimization speed. In Equation 7, fₜ(xᵢ) is the prediction of the t-th tree.

$$L ( θ ) = {\sum }_{i} [ {g}_{i} {f}_{t} ( {x}_{i} ) + \frac{1}{2} {h}_{i} {f}_{t}^{2} ( {x}_{i} ) ] \qquad ( 7 )$$

The machine-learning models can include a rule induction algorithm, such as the MLGB-rules machine-learning model, to discover logical rules for identifying a target class. The rule induction algorithm can generate a set of candidate rules and can select rules from the candidates that best discriminate between the target class and other classes. In some examples, the rules may be generated in the form of “IF (condition 1) AND (condition 2) AND . . . AND (condition n) THEN (target class)” in which each condition may be a comparison between a feature and a value. Additionally, or alternatively, the rule induction model may select rules based on criteria such as precision, recall, F1 score, and the like. An example of a criterion is precision as produced in Equation 8 below. In equation 8, TP is the number of true positives, and FP is the number of false positives.

$$Precision = \frac{T P}{( T P + F P )} \qquad ( 8 )$$

The machine-learning models can include a decision tree classifier. The decision tree can include a non-parametric, supervised learning technique that can partition the data into subsets based on a series of decisions such as based on a splitting criterion. An example of the splitting criterion is produced in Equation 9 below in which pᵢ is the proportion of samples belonging to class i. The technique can select the split that minimizes the Gini impurity of the resulting subsets.

$$G i n i = 1 - {\sum }_{i} {p}_{i}^{2} \qquad ( 9 )$$

The decision tree can be constructed recursively starting from the root node and splitting the data at each node until a stopping criterion is met. Examples of the stopping criterion can include a maximum tree depth, minimum samples per leaf, etc. The parameters of the decision tree can be tuned, and rules can be iterated and transformed into binary attributes. In some examples, the decision tree can be generated based on the binary attributes and can generate output based on rulesets derived from decisions on the binary attributes. The output rule sets can be grouped into a predetermined number of risk levels to combine fewer accounts at a highest risk level and to increase a number of accounts in lower risk levels.

The output from the decision tree can be blended with one or more other scores from outputs from the machine-learning models. For example, the score from the XGBoost model can be combined with a score based on the risk level output by the decision tree. Recommendation rules can be generated based on the combined scores, other output from the machine-learning models, or any combination thereof. The recommendation rules can be generated by leveraging advanced machine-learning techniques to discover a set of rules for identifying interaction stacking bad requests. In examples in which a request triggers a particular rule, the request may be flagged as a “yes”, or the rule for the request may be flagged as a “yes”, indicating that the request may be associated with interaction stacking bad. In some examples, final rules for the machine-learning models may use historical interaction data and may not use one or more elements from the identity data. The final rules can have a format such as “if (num_of_inq_cnf_fin_in_90d>=2.0 and num_of_inq_entity_medium_in_30d>3.5) THEN ‘Yes’ ELSE ‘NO’ END”.

For each rule triggering “Yes” for a request, the rule may be appended or otherwise associated with a risk level to rank-order the triggered rules. Rules can be trained using the interaction stacking bad 1-label and the interaction stacking bad 2-label as separate target variables. Different iterations of training can be performed to arrive at selected rules. For each iteration, a common, predetermined number of rules can be trained for having a highest accuracy and coverage. A multi-step procedure can be used to train the rules in each iteration. One step can involve selecting the best parameters for keeping precision and recall constant. Another step can involve determining highest accuracy rules. Another step can involve optimizing rules for thresholds without impacting overall performance. Another step can involve determining medium accuracy-medium coverage rules by lowering the precision threshold or value and keeping the recall threshold or value the same. Another step can involve checking performance and optimization for the foregoing rules. Another step can involve determining low accuracy-medium-high coverage rules by further lowering the precision threshold or value while retaining the recall threshold or value. Another step can include checking lower accuracy rules for performance and optimization. A final set of recommendation rules can be determined from the above. From the rules, risk levels can be determined. A binary attribute, such as a zero/one attribute, can be created for each of the final rules with a target of interaction stacking bad 1. A decision tree can be trained on the data to compute the risk levels.

The machine-learning models can generate multiple outputs. For example, the multiple outputs can include a decision score and a recommendation score. The decision score can be determined based on identity data without historical interaction data, and the recommendation score can be determined based on historical interaction data without the identity data. The different scores can be presented separately in a recommendation output in response to receiving a request. In some examples, the different scores can be combined and presented as a single, concatenated score in the recommendation output.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Techniques for Interaction Stacking Detection

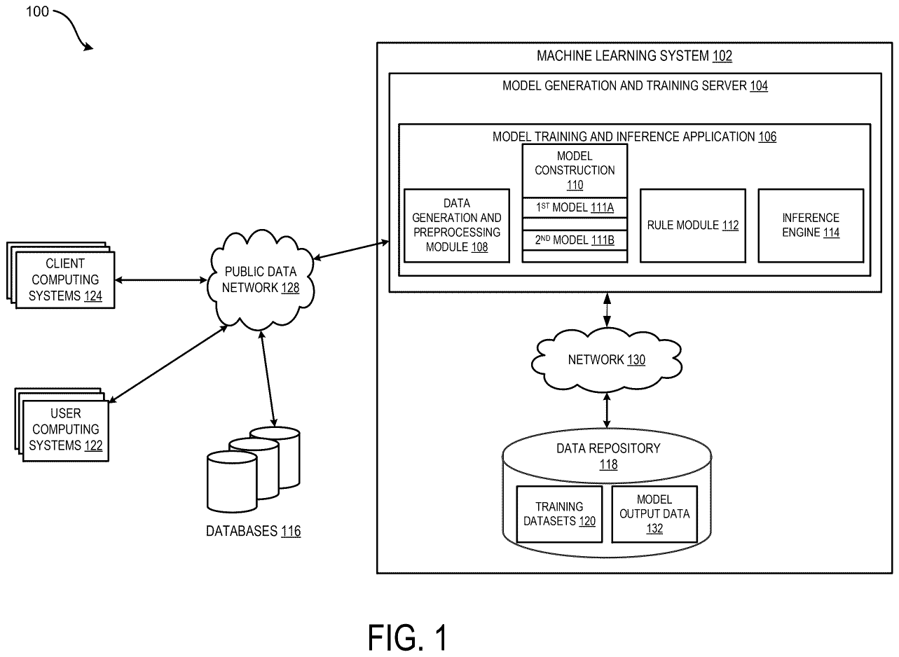

Referring now to the drawings, FIG. 1 is a block diagram depicting an example of an operating environment 100 in which machine-learning techniques can be used for controlling interaction requests based on detecting interaction stacking according to some aspects of the present disclosure. FIG. 1 depicts examples of hardware and software components of the machine-learning system 102, which may be a specialized or general-purpose computing system capable of processing large datasets and performing complex calculations. The machine-learning system 102 can include a model generation and training server 104 for training various machine-learning models to support operations with respect to the operating environment 100 and for deploying the various machine-learning models for real-world applications such as for generating scores or predictions or for making decisions.

The model generation and training server 104 can include one or more processing devices that execute a model training and inference application 106, which includes various modules designed to handle the preprocessing, construction, training, and inference tasks associated with the machine-learning models. Some examples of the modules may include a data generation and preprocessing module 108, a model construction module 110, a rule module 112, and an inference engine 114, though other modules, engines, and the like are possible to include in the model training and inference application 106.

The data generation and preprocessing module 108 may be responsible for receiving raw input data, addressing missing values, transforming the data into a suitable format for further processing, other suitable tasks, or any combination thereof. For example, the data generation and preprocessing module 108 may be configured to receive identity data, historical interaction data, or any combination thereof, and the data generation and preprocessing module 108 may preprocess the data into a dataset that can be used to train models generated by the model construction module 110. The model construction module 110 can be used to generate the machine-learning models that can be used in the operating environment 100. For example, the model construction module 110 can generate a first model 111A, a second model 111B, other suitable models, or any combination thereof. The first model 111A may be constructed to receive identity data for generating a probability score based on a first set of rules. The first model 111A may include an ensemble model that can generate the first set of rules based on attributes of the identity data and can generate the probability score based on the generated rules. The second model 111B may be configured to be provided with a second set of rules to generate an indication of risk based on historical interaction data.

The rule module 112 may be used to generate the first set of rules, the second set of rules, or any combination thereof. For example, the rule module 112 may use the first model 111A, the second model 111B, or any combination or subset thereof, to generate the first set of rules, the second set of rules, or any other suitable sets of rules. The rules may be generated based on attributes in the identity data or historical interaction data. The inference engine 114 may include one or more algorithms that can be used to implement the machine-learning models generated by the model construction module 110 based on the rules generated by the rule module 112. The inference engine 114 may cause the machine-learning models to generate predictions, classifications, scores, or any combination thereof.

The model generation and training server 104 can interact with a data repository 118 via a network 130. The data repository 118 can store one or more datasets, which can include training datasets 120 and model output data 132. The training datasets 120 may be used to train the machine-learning models and may include identity data that can be separate from historical interaction data. The training datasets may include incomplete, fragmented, or missing data attributes for data records within the dataset. The model output data 132 may include the results generated by the machine-learning models, and the results can include predictions, confidence intervals or scores, probabilities, risk levels, and the like, which may be stored for further analysis or use in recommendations or decision-making processes.

In some aspects, the model generation and training server 104 can perform additional tasks related to the validation and deployment of the machine-learning model, using the modules within the model training and inference application 106. The server may receive external datasets from databases 116 or data input systems, which can feed new data into the machine-learning models for ongoing training or real-time inference. The databases 116 may store external data sources such as documents, records, or other relevant data that can be used to enhance the performance of the model. For example, the databases 116 can store identity data, historical interaction data, or other suitable information. The data input systems can represent external data feeds or sensors that provide real-time data such as for immediate processing. For example, the databases 116 or the data input systems may include a new data point for which a prediction or other output is to be obtained based on the trained machine-learning models such as included within the inference engine 114. The model generation and training server 104, or other component illustrated in FIG. 1, may allow for predictions to be made even if a data point is missing one or several data elements.

The data repository 118 or other network-attached storage units within the operating environment 100 may store a variety of different types of data organized in various ways and from multiple sources. The network-attached storage unit may include storage beyond the primary storage located within the model generation and training server 104 that may be directly accessible by the processors therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the machine-learning system 102 can communicate with various other computing systems. The other computing systems can include user computing systems 122, such as smartphones, personal computers, etc., client computing systems 124, other suitable computing systems, or any combination thereof. While FIG. 1 illustrates that the machine-learning system 102 and the client computing systems 124 are separate systems, the machine-learning system 102 and the client computing systems 124 can be one system. For example, the machine-learning system 102 can be a part of the client computing systems 124, or vice versa. The client computing systems 124 may deploy the machine-learning models in a model deployment environment, such as an online platform or service where the model generates predictions based on new data or data stored in the databases 116. In other examples, the client computing system 124 may transmit requests to initiate interactions to the machine-learning system 102 that can invoke the machine-learning models to generate and transmit recommendations or control commands to the client computing systems 124 for responding to the requests.

The machine-learning system 102 may communicate with various other computing systems via one or more data networks such as the public data network 128. The communications can involve transferring data for further processing, receiving updates to the machine-learning models, delivering outputs to end-users or other systems, or any combination thereof. The public data network 128 may include a combination of wired and wireless connections such as for supporting a robust and scalable infrastructure for large-scale data processing and machine-learning tasks.

In some examples, the client computing systems 124 may include other computing resources associated therewith such as server computers hosting and managing virtual machine instances for providing cloud computing services, server computers hosting and managing online storage resources for users, server computers for providing database services, and others. The interaction between the user computing systems 122, the client computing systems 124, and the machine-learning system 102, or any suitable sub-combination thereof, may be performed through graphical user interfaces, such as the user interface, presented by the machine-learning system 102, the client computing systems 124, other suitable computing systems of the computing environment 100, or any suitable combination thereof. The graphical user interfaces can be presented to the user computing systems 122. Application programming interface (API) calls, web service calls, or other suitable techniques can be used to facilitate interaction between any suitable combination or sub-combination of the client computing systems 124, the user computing systems 122, and the machine-learning system 102.

A user computing system 122 can include any computing device or other communication device that can be operated by a user or entity, such as the user entity, which may include a consumer, a customer, or other using entity. The user computing system 122 can include one or more computing devices such as laptops, smartphones, and other personal computing devices. A user computing system 122 can include executable instructions stored in one or more non-transitory computer-readable media. The user computing system 122 can additionally include one or more processing devices configured to execute program code to perform various operations. In various examples, the user computing system 122 can allow a user to access certain online services or other suitable products, services, or computing resources from a target entity, such as the client computing system 124, to engage in mobile commerce with the client computing system 124, to obtain controlled access to electronic content, such as an interactive computing environment, hosted by the client computing system 124, etc.

In a simplified example, the system illustrated in FIG. 1 can configure the model generation and training server 104 to be used for generating predictions based on information from the client computing systems 124, the user computing systems 122, or a combination thereof. The model generation and training server 104 can retrieve data sources associated with one or more of the computing systems in response to a request to perform a prediction or to re-train a machine-learning model. The data sources may, for example, be retrieved from databases 116 or received via other suitable computing systems. The databases 116 can store, for example, data sources such as articles or other publications periodically scraped from the Internet, new data generated by inquiries or new entities identified, etc. The model generation and training server 104 can determine a risk indicator associated with the target entity by extracting and analyzing text from a data source to determine the target entity's involvement in certain events and sentiment scores associated with the events. The model generation and training server 104 can use a data record, or any inference derived therefrom, as an input to the machine-learning models to generate output that can be sent to the client computing system 124 as an output prediction.

Each communication within the operating environment 100 may occur over one or more data networks, such as a public data network 128, the network 130, such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices illustrated in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a signal device or system.

Flowchart for Detecting and Controlling Interaction Stacking Requests using Machine-Learning

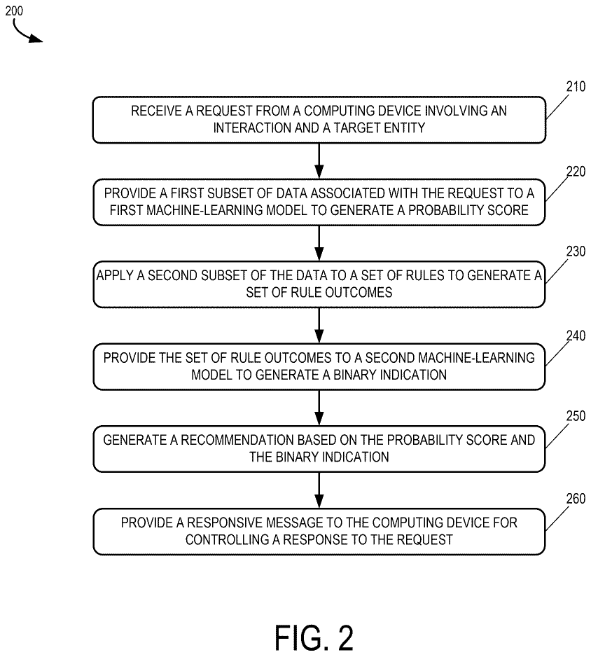

FIG. 2 is a flowchart illustrating an example of a process 200 for controlling interaction requests based on detecting interaction stacking using machine-learning techniques according to some aspects of the present disclosure. In some examples, the operations of the process 200, or any subset thereof, may be performed by a machine-learning optimization system via a training server, but other suitable systems, devices, or subsets or combinations thereof, such as those relating to the operating environment 100, may perform one or more operations described with respect to the process 200. For illustrative purposes, the process 200 is described with reference to certain examples depicted in the figures and in a particular order. Other implementations and orders, including at least partially substantially contemporaneously, are possible.

At block 210, the process 200 involves receiving a request from a computing device. The request can be associated with an interaction involving a target entity. For example, the target entity may have used the computing device to generate and transmit the request to a client system or to the operating environment 100. The request may involve a request to initiate the interaction. In some examples, the request, or the interaction, may be suspected of interaction stacking, and the request may be provided to the operating environment 100, or any component thereof, for analysis, recommendation, control, or any combination thereof. In some examples, data associated with the request can be received. The data can include identity data associated with the target entity, can include historical interaction data associated with historical interactions, or requests for interactions, involving the target entity, or a combination thereof.

At block 220, the process 200 involves providing a first subset of received data to a first machine-learning model of a set of machine-learning models included in the operating environment 100. The first subset may include identity data associated with the target entity and may exclude the historical interaction data. The first machine-learning model may include an ensemble model that can include multiple sub-models. The sub-models can include a gradient boosting model, a decision tree, and the like. For example, the gradient boosting model can receive the first subset and can use attributes thereof to generate a first set of rules that can be provided as binary attributes to the decision tree. The decision tree can receive the binary attributes and can generate a probability score. The probability score can indicate a risk level associated with the target entity without considering historical interactions. For example, the probability score can indicate a likelihood that the request is not legitimate based on an analysis of the identity data of the target entity. In some examples, the probability score can be derived by combining a risk level from the decision tree and a score from the gradient boosting model.

At block 230, the process 200 involves applying a second subset of the received data to a set of rules. The set of rules can include a second set of rules, and applying the second subset of the data to the set of rules can cause a set of rule outcomes to be generated. In some examples, the second subset of the data can include the historical interaction data and can omit the identity data associated with the target entity. Additionally, or alternatively, the set of rule outcomes can indicate whether each rule of the set of rules is triggered by the historical data, and each triggered rule of the set of rules can be provided as input to the second machine-learning model that generates a risk level based on an analysis of each triggered rule of the set of rules.

At block 240, the process 200 involves providing the set of rule outcomes to a second machine-learning model to generate second output. The second output can include a risk level indication of whether the request is legitimate. For example, if the set of rules includes 15 rules, and three rules are triggered, the rule outcomes (e.g., triggered for each of the three rules) for the three rules can be provided to the second machine-learning model for generating a risk level indication of whether the request is legitimate. The rule outcomes (e.g., not triggered) for the remaining rules may also be provided to the second machine-learning model to support generation of the risk level indication.

At block 250, the process 200 involves generating a recommendation. The recommendation can be generated based on the probability score and the risk level indicator generated by the first machine-learning model and the second machine-learning model, respectively. In some examples, the recommendation may present the probability score and the risk level indicator separately as individual scores or indicators. In other examples, the recommendation may be generated to combine the outputs from the first machine-learning model and the second machine-learning model into a single score or indicator for more efficient decision-making.

At block 260, the process 200 involves providing a responsive message. The responsive message can be generated based on the recommendation and can be provided to the computing device from which the request originated. In some examples, the responsive message can include the recommendation. That is, the probability score, the risk level indicator, other suitable outputs from the first machine-learning model or the second machine-learning model, or any combination thereof, can be included in the responsive message. Additionally, or alternatively, the responsive message may include a command that can be executed to control a response to the request. For example, the command may be executed by the computing system to automatically deny the request or to automatically prevent the interaction from being initiated. Additionally, or alternatively, the command may be executed by the computing system to automatically initiate and control procession of the interaction.

### Examples of Data Flows for Detecting and Controlling Interaction Stacking Requests Using Machine-Learning

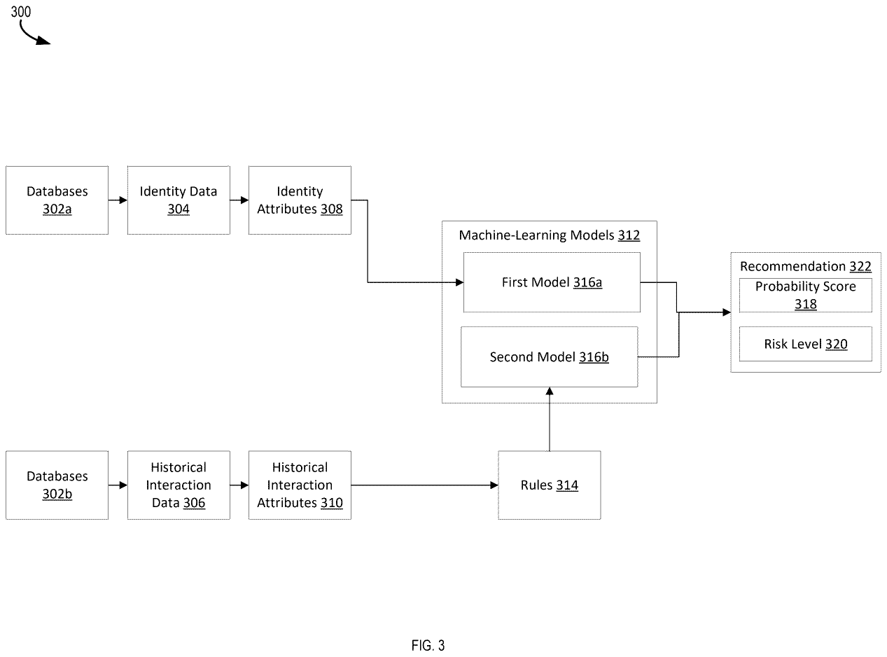

FIG. 3 is a data flow diagram of a data flow 300 for generating a recommendation using machine-learning techniques to detect interaction stacking according to some aspects of the present disclosure. As illustrated in FIG. 3, the data flow 300 may begin with databases such as databases 302a and databases 302b. In some examples, the databases 302a and the databases 302b may be similar or may overlap with one another. In other examples, the databases 302a may be disjunctive with respect to the databases 302b. Examples of data hosted by the databases can include identity data for various entities, historical interaction data associated with the various entities, and the like. For example, the databases 302a can include identity data gleaned from past interactions or from account data accessible to the databases 302a. Additionally, or alternatively, the databases 302b can include historical interaction data for historically requested or initiated interactions involving various entities. From the databases 302a, identity data 304 can be retrieved or otherwise received, and from the databases 302b, historical interaction data 306 can be retrieved or otherwise received. The identity data 304 can include various types of identity data for a target entity requesting an interaction. Additionally, or alternatively, the historical interaction data 306 can include various types of interaction data from historical interactions previously requested by the target entity.

In response to receiving a request from the target entity to initiate an interaction, the databases 302a and the databases 302b can be queried to receive the identity data 304 and the historical interaction data 306. Identity attributes 308 can be extracted from the identity data 304, and historical interaction attributes 310 can be extracted from the historical interaction data 306. The identity attributes 308 can be provided to one or more machine-learning models included in machine-learning models 312, and the historical interaction attributes 310 can be provided to a set of rules 314.

The machine-learning models 312 can include a first model 316a and a second model 316b, though additional models are also possible to include in the machine-learning models 312. The first model 316a may include an ensemble model that includes multiple sub-models, and the second model 316b may include a classification model. The multiple sub-models can include a gradient boosting model and a decision tree. In some examples, the first model 316a and the second model 316b may be combined into a single model such as by having the first model 316a and the second model 316b as sub-models of an overarching machine-learning model. In other examples, the first model 316a may be separate and distinct with respect to the second model 316b.

The identity attributes 308 can be provided to the first model 316a or any sub-model thereof. For example, the identity attributes 308 can be provided to a gradient boosting sub-model of the first model 316a. The gradient boosting sub-model may use a rule induction algorithm to generate a set of rules, which may be separate from the rules 314, that can be used to determine binary attributes for a decision tree sub-model of the first model 316a. In an example, the gradient boosting sub-model can generate the set of rules and can determine which of the rules are invoked by the identity attributes 308. The invoked rules are assigned a first binary value as an attribute while the remaining rules are assigned a second binary value as an attribute. The binary attributes can be provided to the decision tree sub-model to cause the decision tree sub-model to generate a probability score 318. In some examples, the probability score 318 can include a numerical score, such as from 0 to 1, from 1 to 999, or in other suitable ranges, that can indicate a likelihood that the request is associated with malicious interaction stacking.

The historical interaction attributes 310 can be provided to the rules 314, for example to generate rule outcomes. In some examples, the rule outcomes can be binary in which a rule can be triggered or not triggered. Whether a particular rule is triggered can be a rule outcome for a respective rule. The rule outcomes can be provided to the second model 316b that can convert the rule outcomes to a risk level 320 that can indicate, based on the historical interactions associated with the target entity, a particular likelihood that the request is associated with malicious interaction stacking.

The probability score 318 and the risk level 320 can be or can be included in first output and second output generated by the machine-learning models 312. In some examples, the machine-learning models 312 can generate a recommendation 322 that can include the probability score 318 and the risk level 320. The recommendation 322 may present the probability score 318 separately from the risk level 320 or may combine the probability score 318 and the risk level 320 into a single score or indication of a particular likelihood that the request is associated with malicious interaction stacking.

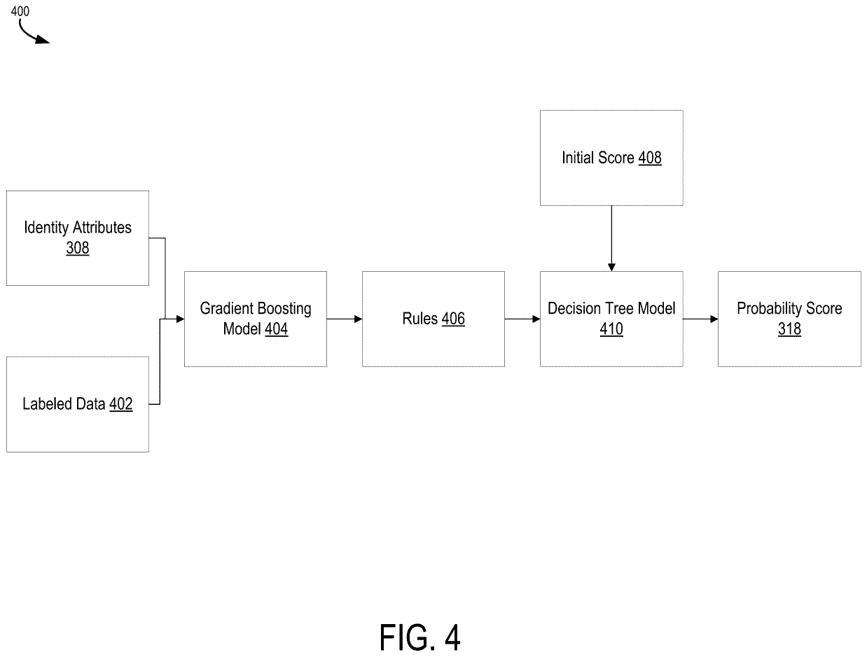

FIG. 4 is a data flow diagram of a data flow 400 for generating a probability score using a machine-learning model based on identity data according to some aspects of the present disclosure. As illustrated in FIG. 4, the data flow 400 may begin with the identity attributes 308 and labeled data 402. In some examples, the labeled data 402 may include labeled data points from a database of various entities. The labeled data 402 may indicate known instances of interaction stacking bad or interaction stacking good by various entities. The identity attributes 308 and the labeled data 402 can be provided to a gradient boosting model 404 that can be used to generate rules 406, which may be different from the rules 314. The gradient boosting model 404 may be included as a part of an ensemble model of the first model 316. Additionally, or alternatively, the gradient boosting model 404 may use a rule induction algorithm to convert the identity attribute 308 to the rules 406 based on the labeled data 402.

The rules 406 can be provided as input along with an initial score 408. The initial score 408 may originate from a different model than the gradient boosting model 404. For example, the initial score may include a risk score for the target entity previously generated, or substantially contemporaneously generated, with respect to the rules 406. The rules 406 and the initial score 408 can be provided as input to a decision tree model 410. In some examples, the rules 406 may be used to generate rule outcomes that can include binary attributes. The decision tree model 410 can use the binary attributes and the initial score 408 to generate the probability score 318. In some examples, the probability score 318 may be an adjusted version of the initial score 408, and the decision tree model 410 can be used to adjust the initial score 408 to the probability score 318 by making multiple decisions based on the binary attributes. The probability score 318 output by the decision tree model 410 can be included in a recommendation such as the recommendation 322.

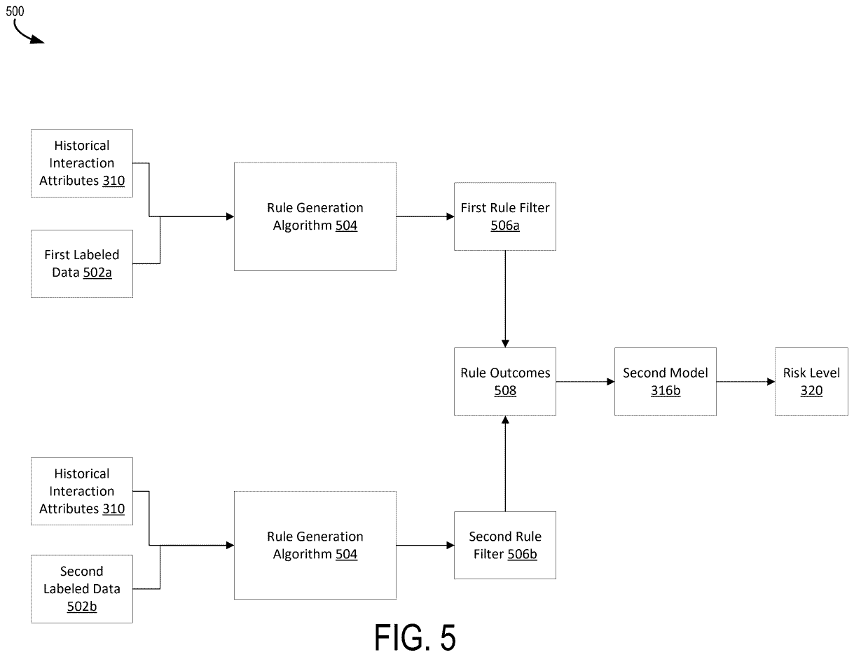

FIG. 5 is a data flow diagram of a data flow 500 for generating an indication of risk using a machine-learning model based on historical interaction data according to some aspects of the present disclosure. As illustrated in FIG. 5, the data flow 500 may begin with a rule generation algorithm 504. The rule generation algorithm 504 can be configured to receive different inputs to generate output that includes a set of rules such as the rules 314. The input to the rule generation algorithm 504 can include historical interaction attributes 310, first labeled data 502a, second labeled data 502b, or any combination thereof. In some examples, multiple sets of different inputs can be provided to different versions or instances of the rule generation algorithm 504 to generate different sets or subsets of rules. For example, and as illustrated in FIG. 5, two different sets of inputs is provided to two different instances of the rule generation algorithm 504, though other suitable numbers are possible.

A first set of inputs provided to a first instance of the rule generation algorithm 504 can include the historical interaction attributes 310 and the first labeled data 502a. The historical interaction attributes 310 can include attributes relating to historical interactions associated with the target entity. The first labeled data 502a may include labeled data points from a database of various historical interactions or requests associated therewith. In a particular example, the first labeled data 502a can include instances of interaction stacking bad associated with entities that may be suspected but not confirmed to have malicious intent with interaction stacking. The rule generation algorithm 504 can receive the historical interaction attributes 310 and the first labeled data 502a and can generate first candidate rules, and a first rule filter 506a can filter the first candidate rules into a first subset of rules. The first rule filter 506a can select rules from the first candidate rules that have high precision, such as a precision exceeding a first precision threshold, in predicting interaction stacking associated with malicious intent. The first rule filter 506a may additionally select rules that model historical interaction behavior of an entity exceeding a first time period.

A second set of inputs provided to a second instance of the rule generation algorithm 504 can include the historical interaction attributes 310 and the second labeled data 502b. The historical interaction attributes 310 can include attributes relating to historical interactions associated with the target entity. The second labeled data 502b may include labeled data points from a database of various historical interactions or requests associated therewith. In a particular example, the second labeled data 502b can include instances of interaction stacking bad associated with entities that may be confirmed to have malicious intent with interaction stacking and may have multiple accounts with interaction stacking that have failed to be fulfilled. The rule generation algorithm 504 can receive the historical interaction attributes 310 and the second labeled data 502b and can generate second candidate rules, and a second rule filter 506b can filter the second candidate rules into a second subset of rules. The second rule filter 506b can select rules from the second candidate rules that have high precision, such as a precision exceeding the first precision threshold, in predicting interaction stacking associated with malicious intent. The second rule filter 506b may additionally select rules that model historical interaction behavior of an entity exceeding a second time period that is shorter than the first time period.

The first subset of rules and the second subset of rules can be combined to form the set of rules such as the rules 314. The set of rules can be used to generate rule outcomes 508. In some examples, the rule outcomes 508 can include, for each rule included in the set of rules, an indication of whether the respective rule has been triggered by historical interaction data associated with the original request to engage in an interaction. The rule outcomes 508 can be provided as input to the second model 316b. In some examples, the second model 316b can include a decision tree model that may be different from the decision tree model 410. The second model 316b may be traversed using the rule outcomes 508, and an output from the second model 316b can include a risk level 320 that can be included in the recommendation 322. In some examples, the risk level 320 can indicate a likelihood that the original request to initiate the interaction is associated with interaction stacking and malicious intent.

### Example of Computing System

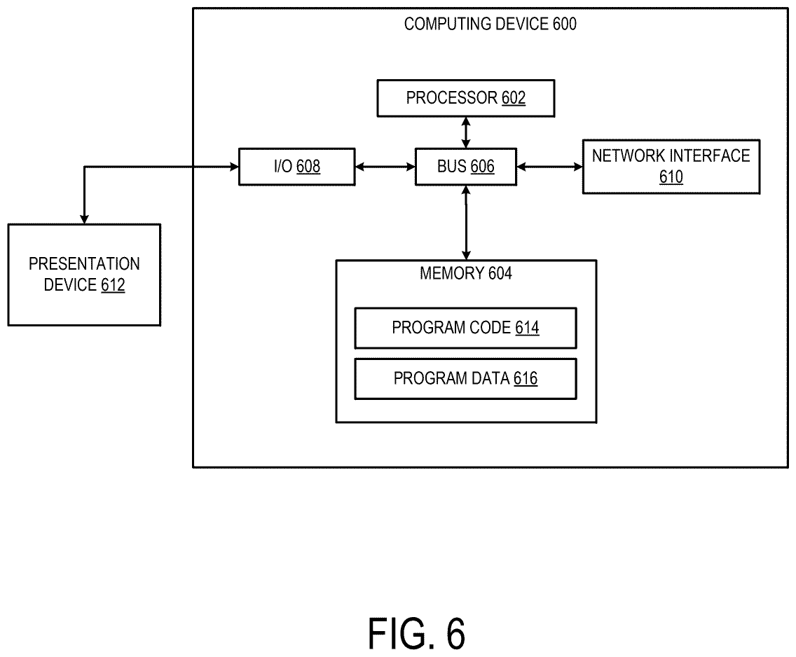

Any suitable computing system or group of computing systems can be used to perform the operations for the techniques described herein. For example, FIG. 6 is a block diagram depicting an example of a computing device 600, which can be used to implement the systems described herein. The computing device 600 can include various devices for communicating with other devices in the operating environment 100, as described with respect to FIG. 1. The computing device 600 can include various devices for performing one or more operations, such as those described above with respect to FIGS. 1-5.

The computing device 600 can include a processor 602 that can be communicatively coupled to a memory 604. The processor 602 can execute computer-executable program code stored in the memory 604, can access information stored in the memory 604, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 602 can include a microprocessor, an application-specific integrated circuit (ASIC), a field-programmable gate array (FPGA), or any other suitable processing device. The processor 602 can include any suitable number of processing devices, including one. The processor 602 can include or communicate with a memory 604. The memory 604 can store program code that, when executed by the processor 602, causes the processor 602 to perform the operations described herein.

The memory 604 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 600 may also include a number of external or internal devices such as input or output devices. For example, the computing device 600 is illustrated with an input/output interface 608 that can receive input from input devices or provide output to output devices. A bus 606 can also be included in the computing device 600. The bus 606 can communicatively couple one or more components of the computing device 600.

The computing device 600 can execute program code 614 that can include the machine-learning models. The program code 614 may be resident in any suitable computer-readable medium and may be executed on any suitable processing device. For example, and as illustrated in FIG. 6, the program code 614 can reside in the memory 604 at the computing device 600 along with the program data 616 associated with the program code 614. Executing the machine-learning model can configure the processor 602 to perform at least a portion of the operations described herein.

In some aspects, the computing device 600 can include one or more output devices. One example of an output device can be or include the network interface device 610 illustrated in FIG. 6. A network interface device 610 can include any device or group of devices suitable for establishing a wired or wireless data connection to one or more data networks described herein. Non-limiting examples of the network interface device 610 can include an Ethernet network adapter, a modem, etc.

Another example of an output device can include the presentation device 612 depicted in FIG. 6. A presentation device 612 can include any device or group of devices suitable for providing visual, auditory, or other suitable sensory output. Non-limiting examples of the presentation device 612 can include a touchscreen, a monitor, a speaker, a separate mobile computing device, etc. In some aspects, the presentation device 612 can include a remote client-computing device that communicates with the computing device 600 using one or more data networks described herein. In other aspects, the presentation device 612 can be omitted.

In some aspects, systems, methods, and non-transitory computer-readable mediums are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a computer-implemented method comprising: receiving, from a computing device, a request associated with an interaction involving a target entity; receiving data about the target entity, the data comprising (i) identity data about the target entity and (ii) historical data about historical interactions associated with the target entity; providing the identity data about the target entity to a first machine-learning model to generate first output comprising a probability score indicating a likelihood that the request is not a legitimate request; applying the historical data about historical interactions associated with the target entity to a set of rules to generate a set of rule outcomes; providing the set of rule outcomes to a second machine-learning model to generate second output comprising a risk level indication of a likelihood that the request is legitimate; generating, by combining the probability score with the risk level indication, a recommendation comprising a response to the request; and providing a responsive message to the computing device, the responsive message comprising a command executable to automatically control the response to the request.

Example 2 is the computer-implemented method of example 1, wherein the set of rules is a first set of rules, and wherein the method further comprises: generating a second set of rules corresponding with the identity data, wherein each rule included in the second set of rules is generated based on one or more attributes from the identity data; transforming the second set of rules into a set of binary attributes; and providing the set of binary attributes to a decision tree of the first machine-learning model to generate the first output.

Example 3 is the computer-implemented method of example 2, wherein providing the set of binary attributes to the decision tree comprises: receiving, from the decision tree, an indication of a risk level for each binary attribute of the set of binary attributes; and combining the indication of the risk level with a score from a gradient boosting model of the first machine-learning model to generate the probability score.

Example 4 is the computer-implemented method of example 1, wherein the set of rule outcomes indicates whether each rule of the set of rules is triggered by the historical data, and wherein each triggered rule of the set of rules is provided as input to the second machine-learning model that generates a risk level based on an analysis of each triggered rule of the set of rules.

Example 5 is the computer-implemented method of example 1, wherein generating the recommendation comprising a response to the request comprises: receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and augmenting the binned numerical value with the cardinal number to generate a hybrid risk value to include in the recommendation.

Example 6 is the computer-implemented method of example 5, further comprising: determining a threshold hybrid risk value associated with the interaction; determining that the hybrid risk value exceeds the threshold hybrid risk value; and outputting a command with the responsive message, the command executable to prevent the interaction from being initiated.

Example 7 is the computer-implemented method of example 1, wherein the first machine-learning model comprises an ensemble model that includes a gradient boost model and a decision tree, wherein the gradient boost model generates rules using a rule induction algorithm, and wherein the decision tree uses the rules as features to generate the probability score.

Example 8 is a system comprising: a processor; and a non-transitory computer-readable medium comprising instructions executable by the processor to perform operations comprising: receiving, from a computing device, a request associated with an interaction involving a target entity; receiving data about the target entity, the data comprising (i) identity data about the target entity and (ii) historical data about historical interactions associated with the target entity; providing the identity data about the target entity to a first machine-learning model to generate first output comprising a probability score indicating a likelihood that the request is not a legitimate request; applying the historical data about historical interactions associated with the target entity to a set of rules to generate a set of rule outcomes; providing the set of rule outcomes to a second machine-learning model to generate second output comprising a risk level indication of a likelihood that the request is legitimate; generating, by combining the probability score with the risk level indication, a recommendation comprising a response to the request; and providing a responsive message to the computing device, the responsive message comprising a command executable to automatically control the response to the request.

Example 9 is the system of example 8, wherein the set of rules is a first set of rules, and wherein the operations further comprise: generating a second set of rules corresponding with the identity data, wherein each rule included in the second set of rules is generated based on one or more attributes from the identity data; transforming the second set of rules into a set of binary attributes; and providing the set of binary attributes to a decision tree of the first machine-learning model to generate the first output.

Example 10 is the system of example 9, wherein the operation of providing the set of binary attributes to the decision tree comprises: receiving, from the decision tree, an indication of a risk level for each binary attribute of the set of binary attributes; and combining the indication of the risk level with a score from a gradient boosting model of the first machine-learning model to generate the probability score.

Example 11 is the system of example 8, wherein the set of rule outcomes indicates whether each rule of the set of rules is triggered by the historical data, and wherein each triggered rule of the set of rules is providable as input to the second machine-learning model that generates a risk level based on an analysis of each triggered rule of the set of rules.

Example 12 is the system of example 8, wherein the operation of generating the recommendation comprising a response to the request comprises: receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and augmenting the binned numerical value with the cardinal number to generate a hybrid risk value to include in the recommendation.

Example 13 is the system of example 12, wherein the operations further comprise: determining a threshold hybrid risk value associated with the interaction; determining that the hybrid risk value exceeds the threshold hybrid risk value; and outputting a command with the responsive message, the command executable to prevent the interaction from being initiated.

Example 14 is the system of example 8, wherein the first machine-learning model comprises an ensemble model that includes a gradient boost model and a decision tree, wherein the gradient boost model generates rules using a rule induction algorithm, and wherein the decision tree is configured to use the rules as features to generate the probability score.

Example 15 is a non-transitory computer-readable medium comprising instructions executable by a processor to cause the processor to perform operations comprising: receiving, from a computing device, a request associated with an interaction involving a target entity; receiving data about the target entity, the data comprising (i) identity data about the target entity and (ii) historical data about historical interactions associated with the target entity; providing the identity data about the target entity to a first machine-learning model to generate first output comprising a probability score indicating a likelihood that the request is not a legitimate request; applying the historical data about historical interactions associated with the target entity to a set of rules to generate a set of rule outcomes; providing the set of rule outcomes to a second machine-learning model to generate second output comprising a risk level indication of a likelihood that the request is legitimate; generating, by combining the probability score with the risk level indication, a recommendation comprising a response to the request; and providing a responsive message to the computing device, the responsive message comprising a command executable to automatically control the response to the request.

Example 16 is the non-transitory computer-readable medium of example 15, wherein the set of rules is a first set of rules, and wherein the operations further comprise: generating a second set of rules corresponding with the identity data, wherein each rule included in the second set of rules is generated based on one or more attributes from the identity data; transforming the second set of rules into a set of binary attributes; and providing the set of binary attributes to a decision tree of the first machine-learning model to generate the first output.

Example 17 is the non-transitory computer-readable medium of example 16, wherein the operation of providing the set of binary attributes to the decision tree comprises: receiving, from the decision tree, an indication of a risk level for each binary attribute of the set of binary attributes; and combining the indication of the risk level with a score from a gradient boosting model of the first machine-learning model to generate the probability score.

Example 18 is the non-transitory computer-readable medium of example 15, wherein the set of rule outcomes indicates whether each rule of the set of rules is triggered by the historical data, and wherein each triggered rule of the set of rules is providable as input to the second machine-learning model that generates a risk level based on an analysis of each triggered rule of the set of rules.

Example 19 is the non-transitory computer-readable medium of example 15, wherein the operation of generating the recommendation comprising a response to the request comprises: receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and augmenting the binned numerical value with the cardinal number to generate a hybrid risk value to include in the recommendation.

Example 20 is the non-transitory computer-readable medium of example 19, wherein the operations further comprise: determining a threshold hybrid risk value associated with the interaction; determining that the hybrid risk value exceeds the threshold hybrid risk value; and outputting a command with the responsive message, the command executable to prevent the interaction from being initiated.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A computer-implemented method comprising:
receiving, from a computing device, a request associated with an interaction involving a target entity;
receiving data about the target entity, the data comprising (i) identity data about the target entity and (ii) historical data about historical interactions associated with the target entity;
providing the identity data about the target entity to a first machine-learning model to generate first output comprising a probability score indicating a likelihood that the request is not a legitimate request;
applying the historical data about historical interactions associated with the target entity to a set of rules to generate a set of rule outcomes;
providing the set of rule outcomes to a second machine-learning model to generate second output comprising a risk level indication of a likelihood that the request is legitimate;
generating, by combining the probability score with the risk level indication, a recommendation comprising a response to the request; and
providing a responsive message to the computing device, the responsive message comprising a command executable to automatically control the response to the request.

2. The computer-implemented method of claim 1, wherein the set of rules is a first set of rules, and wherein the method further comprises:
generating a second set of rules corresponding with the identity data, wherein each rule included in the second set of rules is generated based on one or more attributes from the identity data;
transforming the second set of rules into a set of binary attributes; and
providing the set of binary attributes to a decision tree of the first machine-learning model to generate the first output.

3. The computer-implemented method of claim 2, wherein providing the set of binary attributes to the decision tree comprises:
receiving, from the decision tree, an indication of a risk level for each binary attribute of the set of binary attributes; and
combining the indication of the risk level with a score from a gradient boosting model of the first machine-learning model to generate the probability score.

4. The computer-implemented method of claim 1, wherein the set of rule outcomes indicates whether each rule of the set of rules is triggered by the historical data, and wherein each triggered rule of the set of rules is provided as input to the second machine-learning model that generates a risk level based on an analysis of each triggered rule of the set of rules.

5. The computer-implemented method of claim 1, wherein generating the recommendation comprising a response to the request comprises:
receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and
augmenting the binned numerical value with the cardinal number to generate a hybrid risk value to include in the recommendation.

6. The computer-implemented method of claim 5, further comprising:
determining a threshold hybrid risk value associated with the interaction;
determining that the hybrid risk value exceeds the threshold hybrid risk value; and
outputting a command with the responsive message, the command executable to prevent the interaction from being initiated.

7. The computer-implemented method of claim 1, wherein the first machine-learning model comprises an ensemble model that includes a gradient boost model and a decision tree, wherein the gradient boost model generates rules using a rule induction algorithm, and wherein the decision tree uses the rules as features to generate the probability score.

8. A system comprising:
a processor; and
a non-transitory computer-readable medium comprising instructions executable by the processor to perform operations comprising:
receiving, from a computing device, a request associated with an interaction involving a target entity;
receiving data about the target entity, the data comprising (i) identity data about the target entity and (ii) historical data about historical interactions associated with the target entity;
providing the identity data about the target entity to a first machine-learning model to generate first output comprising a probability score indicating a likelihood that the request is not a legitimate request;
applying the historical data about historical interactions associated with the target entity to a set of rules to generate a set of rule outcomes;
providing the set of rule outcomes to a second machine-learning model to generate second output comprising a risk level indication of a likelihood that the request is legitimate;
generating, by combining the probability score with the risk level indication, a recommendation comprising a response to the request; and
providing a responsive message to the computing device, the responsive message comprising a command executable to automatically control the response to the request.

9. The system of claim 8, wherein the set of rules is a first set of rules, and wherein the operations further comprise:
generating a second set of rules corresponding with the identity data, wherein each rule included in the second set of rules is generated based on one or more attributes from the identity data;
transforming the second set of rules into a set of binary attributes; and
providing the set of binary attributes to a decision tree of the first machine-learning model to generate the first output.

10. The system of claim 9, wherein the operation of providing the set of binary attributes to the decision tree comprises:
receiving, from the decision tree, an indication of a risk level for each binary attribute of the set of binary attributes; and
combining the indication of the risk level with a score from a gradient boosting model of the first machine-learning model to generate the probability score.

11. The system of claim 8, wherein the set of rule outcomes indicates whether each rule of the set of rules is triggered by the historical data, and wherein each triggered rule of the set of rules is providable as input to the second machine-learning model that generates a risk level based on an analysis of each triggered rule of the set of rules.

12. The system of claim 8, wherein the operation of generating the recommendation comprising a response to the request comprises:
receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and
augmenting the binned numerical value with the cardinal number to generate a hybrid risk value to include in the recommendation.

13. The system of claim 12, wherein the operations further comprise:
determining a threshold hybrid risk value associated with the interaction;
determining that the hybrid risk value exceeds the threshold hybrid risk value; and
outputting a command with the responsive message, the command executable to prevent the interaction from being initiated.

14. The system of claim 8, wherein the first machine-learning model comprises an ensemble model that includes a gradient boost model and a decision tree, wherein the gradient boost model generates rules using a rule induction algorithm, and wherein the decision tree is configured to use the rules as features to generate the probability score.

15. A non-transitory computer-readable medium comprising instructions executable by a processor to cause the processor to perform operations comprising:
receiving, from a computing device, a request associated with an interaction involving a target entity;
receiving data about the target entity, the data comprising (i) identity data about the target entity and (ii) historical data about historical interactions associated with the target entity;
providing the identity data about the target entity to a first machine-learning model to generate first output comprising a probability score indicating a likelihood that the request is not a legitimate request;
applying the historical data about historical interactions associated with the target entity to a set of rules to generate a set of rule outcomes;
providing the set of rule outcomes to a second machine-learning model to generate second output comprising a risk level indication of a likelihood that the request is legitimate;
generating, by combining the probability score with the risk level indication, a recommendation comprising a response to the request; and
providing a responsive message to the computing device, the responsive message comprising a command executable to automatically control the response to the request.

16. The non-transitory computer-readable medium of claim 15, wherein the set of rules is a first set of rules, and wherein the operations further comprise:
generating a second set of rules corresponding with the identity data, wherein each rule included in the second set of rules is generated based on one or more attributes from the identity data;
transforming the second set of rules into a set of binary attributes; and
providing the set of binary attributes to a decision tree of the first machine-learning model to generate the first output.

17. The non-transitory computer-readable medium of claim 16, wherein the operation of providing the set of binary attributes to the decision tree comprises:
receiving, from the decision tree, an indication of a risk level for each binary attribute of the set of binary attributes; and
combining the indication of the risk level with a score from a gradient boosting model of the first machine-learning model to generate the probability score.

18. The non-transitory computer-readable medium of claim 15, wherein the set of rule outcomes indicates whether each rule of the set of rules is triggered by the historical data, and wherein each triggered rule of the set of rules is providable as input to the second machine-learning model that generates a risk level based on an analysis of each triggered rule of the set of rules.

19. The non-transitory computer-readable medium of claim 15, wherein the operation of generating the recommendation comprising a response to the request comprises:
receiving a first risk level from the first machine-learning model and a second risk level from the second machine-learning model, wherein the first risk level is a binned numerical value based on a second set of rules applied to the identity data, and wherein the second risk level is a cardinal number based on the set of rules applied to the historical data; and
augmenting the binned numerical value with the cardinal number to generate a hybrid risk value to include in the recommendation.

20. The non-transitory computer-readable medium of claim 19, wherein the operations further comprise:
determining a threshold hybrid risk value associated with the interaction;
determining that the hybrid risk value exceeds the threshold hybrid risk value; and
outputting a command with the responsive message, the command executable to prevent the interaction from being initiated.
